(19) United States
(12) Patent Application Publication
(10) Pub. No.: US 2020/0185161 A1
(43) Pub. Date: Jun. 11, 2020

(54) PRE-LITHIATION OF LITHIUM ION CAPACITORS

(71) Applicant: Applied Materials, Inc., Santa Clara, CA (US)

(72) Inventor: Subramanya P. HERLE, Mountain View, CA (US)

(21) Appl. No.: 16/575,812

(22) Filed: Sep. 19, 2019

Related U.S. Application Data
(60) Provisional application No. 62/776,920, filed on Dec. 7, 2018.

(51) Int. Cl. H01G 11/86; H01G 11/50; H01G 11/06

(52) U.S. Cl. CPC H01G 11/86; H01G 11/06; H01G 11/50

(57) ABSTRACT

The present disclosure generally relates to a method and apparatus for uniformly pre-lithiating one or more lithium ion capacitor anodes. A substrate comprising one or more anodes is provided to a flexible substrate coating apparatus as a continuous sheet of anode material, and a lithium layer is uniformly and directly deposited onto one or more sides of the substrate using the flexible substrate coating apparatus.

### CROSS-REFERENCE TO RELATED APPLICATIONS

This application claims benefit of U.S. provisional patent application Ser. No. 62/776,920, filed Dec. 7, 2018, which is herein incorporated by reference.

### BACKGROUND

### Field

Embodiments of the present disclosure generally relate to methods of pre-lithiating lithium ion capacitors.

### Description of the Related Art

Lithium ion capacitors (LICs) are a class of advanced asymmetric or hybrid energy storage devices containing functionalities derived from both batteries and electric double-layer capacitors. Many LICs utilize a high-surface area activated carbon (AC) as the positive electrode (i.e., cathode) and an intercalation compound, which supports the fast reversible intercalation of lithium ions, as the negative electrode (i.e., anode). During charge/discharge, lithium ion intercalation/de-intercalation occurs within the bulk of the negative electrode, whereas, anion adsorption/desorption occurs on the surface of the corresponding positive electrode. As the latter process on the positive electrode is non-Faradaic, and is relatively fast in comparison with the lithium-ion exchange process at the negative electrode, the power capability of an LIC will be determined, or limited, by the rate capability of the negative electrode.

To increase the rate capability of the anode, graphite pre-doped with lithium ions (pre-lithiated) may be used as the negative electrode. The pre-lithiation of the graphite anode is achieved by using an additional internal sacrificial lithium foil during device fabrication and an electrochemically short, porous anode current collector to pre-lithiate lithium ions across the LIC. In this electrochemical process, pre-lithiated ions are moving across multiple layers of the positive and negative electrodes though a thick porous current collector, which may result in the lithium ions being deposited on the anode non-uniformly. Furthermore, pre-lithiation methods utilizing sacrificial lithium foil during device fabrication can be both expensive and time-consuming, increasing manufacturing time and reducing efficiency and yield.

Therefore, there is a need in the art for an efficient method for uniformly pre-lithiating anodes in lithium ion capacitors.

### SUMMARY

The present disclosure generally relates to a method and apparatus for uniformly pre-lithiating one or more lithium ion capacitor anodes. A substrate comprising one or more anodes is provided to a flexible substrate coating apparatus as a continuous sheet of anode material, and a lithium layer is uniformly and directly deposited onto one or more sides of the substrate using the flexible substrate coating apparatus.

In one embodiment, a method for pre-lithiating one or more lithium ion capacitor anodes comprises providing a substrate to a flexible substrate coating apparatus as a continuous sheet of anode material. The substrate comprises one or more anodes. The method further comprises depositing a lithium layer onto one or more sides of the substrate using the flexible substrate coating apparatus.

In another embodiment, a method for pre-lithiating one or more lithium ion capacitor anodes comprises providing a substrate to a flexible substrate coating apparatus as a continuous sheet of anode material. The substrate comprises one or more anodes. The method further comprises depositing a lithium layer onto one or more sides of the substrate using the flexible substrate coating apparatus, and depositing a surface protection layer on the lithium layer using the flexible substrate coating apparatus.

In yet another embodiment, a flexible substrate coating apparatus comprises a vacuum process chamber for processing a flexible substrate. The vacuum process chamber comprises a coating drum and one or more deposition units radially disposed around the coating drum. At least one deposition unit of the one or more deposition units is configured to uniformly deposit a lithium layer on the flexible substrate. The flexible substrate comprises one or more anodes.

In yet another embodiment, a method for pre-lithiating one or more lithium ion capacitor anodes comprises doping lithium ions onto a substrate comprising one or more anodes using thermal evaporation, and depositing a surface protection layer on the lithium ion doped substrate.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a lithium ion capacitor comprising an anode and a cathode, according to one embodiment.

FIG. 2 illustrates a method of pre-lithiating an anode in a lithium ion capacitor using a flexible substrate coating apparatus, according to one embodiment.

FIG. 3 illustrates a schematic view of a flexible substrate coating apparatus for forming anode electrode structures according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to a method and apparatus for uniformly pre-lithiating one or more lithium ion capacitor anodes. A substrate comprising one or more anodes is provided to a flexible substrate coating apparatus as a continuous sheet of anode material, and a lithium layer is uniformly and directly deposited onto one or more sides of the substrate using the flexible substrate coating apparatus.

Some embodiments described herein will be described below in reference to a roll-to-roll coating system, such as a TopMet® roll-to-roll web coating system, a SMARTWEB® roll-to-roll web coating system, a TOPBEAM® roll-to-roll web coating system, all of which are available from Applied Materials, Inc. of Santa Clara, Calif. Other tools capable of performing high rate deposition processes may also be adapted to benefit from the embodiments described herein. In addition, any system enabling the deposition processes described herein can be used to advantage. The apparatus description described herein is illustrative and should not be construed or interpreted as limiting the scope of the embodiments described herein. It should also be understood that although described as a roll-to-roll process, the embodiments described herein may also be performed on discrete substrates.

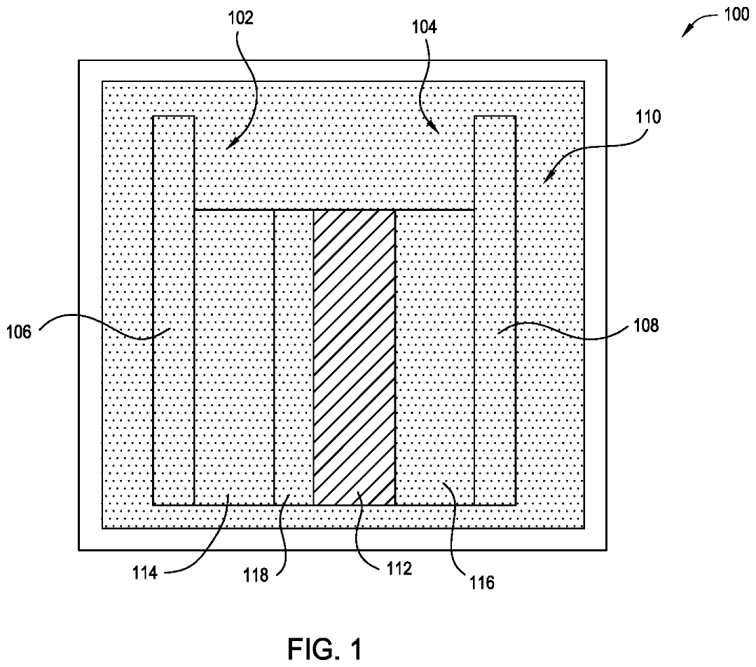

FIG. 1 illustrates a lithium ion capacitor (LIC) 100 having an anode 102 in ionic communication with a cathode 104. The anode 102 and the cathode 104 may be immersed in an electrolyte 110. The electrolyte 110 may provide a transport of ionic species between the anode 102 and the cathode 104. The electrolyte 110 may include an electrolyte solvent and an electrolyte salt comprising an anion and a cation. The electrolyte 110 may be a non-aqueous electrolyte conductive of lithium ions. The electrolyte salt to be dissolved in the electrolyte solvent may be a salt capable of transferring lithium ions and which will not cause electrolysis at high voltages. The electrolyte salt to be dissolved in the electrolyte solvent may further be a salt in which lithium ions can be stably present. The electrolyte 110 may comprise a lithium salt, such as lithium perchlorate (LiClO₄), lithium fluoroarsenate (LiAsF₄), lithium bis(trifluoro-methansulfonyl)imide (LiN(SO₂CF₃)₂), lithium trifluoromethan-sulfonate (LiSO₃CF₃), lithium tetrafluoroborate (LiBF₄), hexafluorophosphate (LiPF₆), combinations thereof, and/or the like.

The electrolyte solvent of the electrolyte 110 may provide a desired salt solubility, viscosity, and/or level of chemical and/or thermal stability for a temperature range. For example, the electrolyte solvent may comprise an ether and/or an ester. The electrolyte solvent may further comprise propylene carbonate, dimethylcarbonate, vinylene carbonate, diethylene carbonate, ethylene carbonate, sulfolane, acetonitrile, dimethoxyethane, tetrahydrofuran, ethylmethyl carbonate, combinations thereof, and/or the like.

The LIC 100 comprises a separator 112 disposed between the anode 102 and the cathode 104. The separator 112 may be configured to permit a transport of ionic species between the anode 102 and the cathode 104, while preventing an electrical short between the anode 102 and the cathode 104. The separator 112 may be comprised of a porous electrically insulating material (i.e., porous material having durability against the electrolyte 110). The separator 112 may have one or more through holes. The separator 112 may comprise a resin, such as cellulose or paper. In one embodiment, a resin or paper comprising a nonwoven fabric is utilized. In another embodiment, the separator 112 comprises a polyethylene or a polypropylene material. The separator 112 may have a thickness between about 2 μm to about 50 μm.

The anode 102 may include an anode current collector 106 and the cathode 104 may include a cathode current collector 108. The anode current collector 106 and/or the cathode current collector 108 may be configured to facilitate an electrical connection between the anode 102 and/or the cathode 104 and an external circuit. The anode current collector 106 and/or the cathode current collector 108 may comprise a conductive material, such as a metallic material. The anode current collector 106 and/or the cathode current collector 108 may be porous or non-porous, and may comprise aluminum, metallized plastic (e.g., Al/PET/Al), copper, silver, gold, platinum, palladium, and/or alloys of the metals. Other suitable conductive materials may also be possible. In at least one implementation, the anode current collector 106 comprises a non-porous material. In one embodiment, the anode current collector 106 and/or the cathode current collector 108 each have a thickness between about 20 μm to about 100 μm.

The anode 102 includes a first anode electrode film 114 disposed between the separator 112 and the anode current collector 106. In some embodiments, the anode 102 may include a second anode electrode film disposed on the opposite side of the anode current collector 106 than the first anode electrode film 114. The anode electrode film 114 comprises an active material. In one embodiment, the anode electrode film 114 comprises a material, which can reversibly intercalate lithium ions. For example, the anode electrode film 114 may comprise a carbon material, which can reversibly intercalate lithium ions, including, but not limited to, a graphite material. In one embodiment, the anode current collector 106 comprises the same active material as the anode electrode film 114. For instance, the anode current collector 106 may be coated in the active material, such as a graphite or carbon coating. The anode electrode film 114 may be pre-lithiated according to one or more of the embodiments described herein. The cathode 104 includes a first cathode electrode film 116 disposed between the separator 112 and the cathode current collector 108. In some embodiments, the cathode 104 may include a second cathode electrode film disposed on the opposite side of the cathode current collector 108 than the first cathode electrode film 116. The cathode electrode film 116 comprises an active material.

The cathode electrode film 116 and the anode electrode film 114 may comprise the same active material. The active material of the cathode electrode film 116 and the anode electrode film 114 may each independently comprise carbon, porous graphite, lithium metal oxide, or a porous carbon material, including, but not limited to, particles of activated carbon. The activated carbon may provide a porosity (e.g., a distribution of micropores, mesopores, and/or macropores) configured to facilitate LIC performance. The cathode electrode film 116 and the anode electrode film 114 may each further comprise a binder component, such as a fluropolymer (e.g., PTFE), polypropylene, polyethylene, PVDF, etc. The cathode electrode film 116 and the anode electrode film 114 may each further comprise other conductive additives such as carbon black, graphite, graphene, CNT, etc. The cathode electrode film 116 and the anode electrode film 114 may each independently comprise about 50% to 99% by weight of the active material. In one embodiment, the cathode electrode film 116 and the anode electrode film 114 each independently comprise 60% to 95% by weight of the active material. The remaining weight balance comprises binder components and conductive additives.

The thickness of the active material of the anode electrode film 114 and the thickness of the active material of the cathode electrode film 116 may be equal (i.e., set in balance with one another) to secure an energy/power density. The thickness of the active material of the anode electrode film 114 and the thickness of the active material of the cathode electrode film 116 may each independently be between about 15 μm to 100 μm. In one embodiment, the thickness of the active material of the anode electrode film 114 and the thickness of the active material of the cathode electrode film 116 is between about 20 μm to 80 μm.

A solid-electrolyte interphase (SEI) layer 118 may optionally be formed adjacent a surface of the anode 102, for example during an anode pre-doping step. In one embodiment, the SEI 118 is disposed between the separator 112 and the anode electrode film 114. In some embodiments, the SEI layer 118 may form due to an electrochemical reaction involving an electrolyte solvent and/or an electrolyte salt at a surface of the lithium ion capacitor anode 102 adjacent to the electrolyte 110. For example, the SEI layer 118 may form due at least in part to a decomposition of one or more components of the electrolyte 110. The solid-electrolyte interphase layer 118 may provide a layer adjacent to the anode 102 which can provide electrical insulation for the anode 102 while being permeable to one or more ionic species.

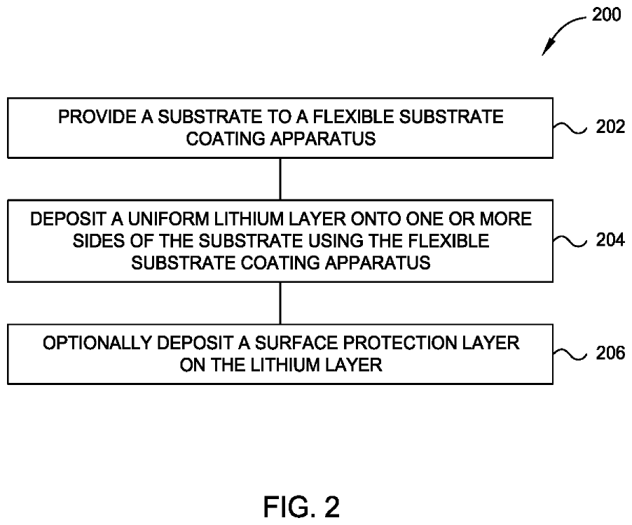

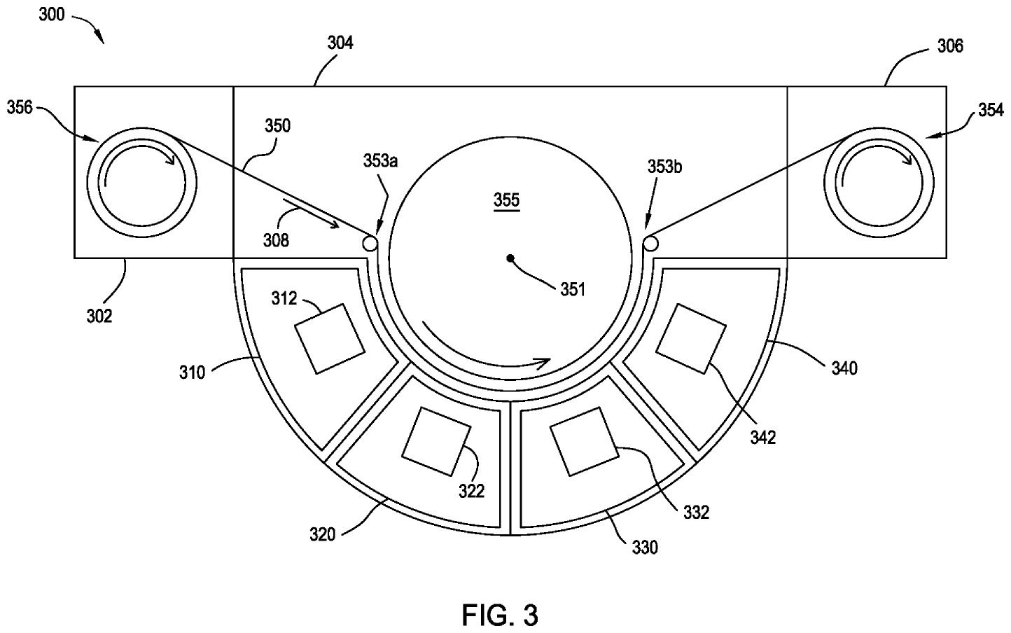

FIG. 2 illustrates a method 200 of pre-lithiating an anode in a lithium ion capacitor using a flexible substrate coating apparatus, according to one embodiment. Method 200 may be utilized with the LIC 100 of FIG. 1. For clarity, aspects of a flexible substrate coating apparatus 300 described in FIG. 3 below are referenced with method 200 for explanatory purposes.

In operation 202, a substrate in the form of a continuous sheet or web of material is provided to a flexible substrate coating apparatus, such as the flexible substrate coating apparatus 300 of FIG. 3. The continuous sheet of material comprises one or more anodes, such as the anode 102 of FIG. 1. The continuous sheet of material may be separated into multiple anodes upon completion of method 200. The one or more anodes of the substrate may comprise a current collector, an electrode, and/or a separator, such as the anode current collector 106, the anode electrode film 114, and the separator 112 of FIG. 1. In one embodiment, the one or more anodes of the substrate are comprised of a non-porous material that is coated in graphite or carbon. The continuous sheet of material may have a thickness between about 50 μm to 300 μm.

The flexible substrate coating apparatus 300 utilized with method 200 may be constituted as a roll-to-roll system including an unwinding module 302, a processing module 304 and a winding module 306. In certain implementations, the processing module 304 comprises a plurality of processing modules or chambers 310, 320, 330, and 340 arranged in sequence, each configured to perform one processing operation to the continuous sheet of material. In one implementation, as depicted in FIG. 3, the processing chambers 310-340 are radially disposed about a coating drum 355. The processing chambers 310-340 each include one or more deposition units 312, 322, 332, and 342, with at least one deposition unit comprising an evaporation source. In one embodiment, each deposition unit comprises an evaporation source, each evaporation source being a lithium source. The lithium to be deposited may be provided in a crucible to the deposition unit comprising the evaporation source. In one embodiment, one or more processing chambers are configured to deposit a graphite or carbon coating on the continuous sheet of material in operation 202.

In operation 204, a lithium layer is uniformly deposited onto one or more sides of the continuous sheet of material using the flexible substrate coating apparatus. While the lithium deposited on the continuous sheet of material is referred to as a “lithium layer”, the deposited lithium may be lithium ions, and is not limited to being a layer or film of lithium. The lithium layer may be continuous or discontinuous. In one embodiment, lithium ions are doped onto one or more sides of the continuous sheet of material using the flexible substrate coating apparatus to form the lithium layer. In another embodiment, the lithium being deposited may be absorbed into the porous anode or may react with the anode material. The continuous sheet of material may be uncoiled from the unwinding module and moved through deposition units of the processing chambers provided at the coating drum 355. The lithium layer may be evaporated by thermal evaporation techniques and deposited on the continuous sheet of material. During operation 204, the coating drum 355 may be chilled to about −20 degrees Celsius or heated to about 60 degrees Celsius to manage a thermal heat-load and to provide an air cushion. In one embodiment, a hardmask is used to limit the lithium deposition to the electrode area of the anodes of the continuous sheet of material, and to prevent deposition on the current collector. In such an embodiment, the hardmask may be temperature controlled. If a hardmask is utilized, the hardmask may be removed after the lithium layer is deposited, prior to proceeding to operation 206.

As the continuous sheet of material moves through the deposition units, a lithium layer is uniformly and directly deposited on the continuous sheet of material. One or more of the deposition units may deposit a portion of the lithium layer on the continuous sheet of material. For example, the processing chambers 310, 320, and 330 may each deposit a portion of the lithium layer on the continuous sheet of material. The lithium layer may be uniformly deposited on only one side of the continuous sheet of material, or may be uniformly deposited on both sides of the continuous sheet of material. In one embodiment, the lithium layer is uniformly deposited on both sides of the continuous sheet of material simultaneously. The lithium layer uniformly deposited on the continuous sheet of material may have a thickness between about 0.01 μm to 5 μm. In one embodiment, the lithium layer uniformly deposited on the continuous sheet of material has a thickness between about 1 μm to 3 μm. Using the flexible substrate coating apparatus allows for direct, precise dosing of lithium on the continuous sheet of material for pre-lithiation.

In operation 206, a removable surface protection layer is optionally deposited on the lithium layer using the flexible substrate coating apparatus. The surface protection layer may be deposited using any processing chamber of the flexible substrate coating apparatus disposed after the one or more lithium depositing processing chambers, such as the processing chamber 340. The processing chamber used to deposit the surface protection layer may comprise a plasma source. The lithium layer may be treated with carbon dioxide (CO₂) as the surface protection layer using the deposition unit comprising the plasma source. In one embodiment, the surface protection layer comprises lithium oxide, lithium carbonate, or lithium fluoride. Deposition of the surface protection layer may comprise depositing lithium fluoride by evaporation of a polymer electrolyte. In some implementations, operation 204 and operation 206 are performed without breaking vacuum meaning that the substrate is not exposed to atmosphere in between processing operations.

Following the deposition of the lithium layer and/or the optional deposition of the surface protection layer, the continuous sheet of material may be used to form one or more LIC anodes. The one or more LIC anodes may be used to form or fabricate lithium ion capacitors, such as the LIC 100 of FIG. 1. For example, an LIC anode having the lithium layer deposited thereon using method 200 may be combined with a separator, a cathode electrode film, and/or a cathode current collector to fabricate a lithium ion capacitor.

FIG. 3 illustrates a schematic view of a flexible substrate coating apparatus 300 for forming anode electrode structures according to implementations described herein. The flexible substrate coating apparatus 300 may be a SMARTWEB®, manufactured by Applied Materials, adapted for manufacturing lithium anode devices according to the implementations described herein. According to typical implementations, the flexible substrate coating apparatus 300 can be used for manufacturing lithium anodes, such as the anode 102 of FIG. 1. The flexible substrate coating apparatus 300 is constituted as a roll-to-roll system including an unwinding module 302, a processing module 304 and a winding module 306.

In certain implementations, the processing module 304 comprises a plurality of processing modules or chambers 310, 320, 330, and 340 arranged in sequence, each configured to perform one processing operation to the continuous sheet of material 350 or web of material. In at least one implementation, the continuous sheet of material 350 comprises one or more anodes. In one implementation, as depicted in FIG. 3, the processing chambers 310-340 are radially disposed about a coating drum 355. Arrangements other than radial are contemplated. For example, in another implementation, the processing chambers may be positioned in a linear configuration. During operation, the coating drum 355 may be chilled to about −15 degrees Celsius or heated to about 60 degrees Celsius to manage a thermal heat-load and to provide an air cushion.

In one implementation, the processing chambers 310-340 are stand-alone modular processing chambers wherein each modular processing chamber is structurally separated from the other modular processing chambers. Therefore, each of the stand-alone modular processing chambers, can be arranged, rearranged, replaced, or maintained independently without affecting each other. Although four processing chambers 310-340 are shown, it should be understood that any number of processing chambers may be included in the flexible substrate coating apparatus 300.

The processing chambers 310-340 may include any suitable structure, configuration, arrangement, and/or components that enable the flexible substrate coating apparatus 300 to deposit a lithium anode device according to implementations of the present disclosure. For example, but not limited to, the processing chambers may include suitable deposition systems including coating sources, power sources, individual pressure controls, deposition control systems, and temperature control. According to typical implementations, the chambers are provided with individual gas supplies. The chambers are typically separated from each other for providing a good gas separation. The flexible substrate coating apparatus 300 according to implementations described herein is not limited in the number of deposition chambers. For example, but not limited to, flexible substrate coating apparatus 300 may include 3, 6, or 12 processing chambers.

The processing chambers 310-340 typically include one or more deposition units 312, 322, 332, and 342. Generally, the one or more deposition units 312, 322, 332, 342 as described herein can be selected from the group of a CVD source, a PECVD source and a PVD source. The one or more deposition units 312, 322, 332, 342 can include an evaporation source, a sputter source, such as, a magnetron sputter source, DC sputter source, AC sputter source, pulsed sputter source, radio frequency (RF) sputtering, or middle frequency (MF) sputtering can be provided. For instance, MF sputtering with frequencies in the range of 5 kHz to 100 kHz, for example, 30 kHz to 50 kHz can be provided. The one or more deposition units 312, 322, 332, 342 can include an evaporation source. In one implementation, the evaporation source is a thermal evaporation source or an electron beam evaporation. In one implementation, the evaporation source is a lithium source. Further, the evaporation source may also be an alloy of two or more metals. The material to be deposited (e.g., lithium) can be provided in a crucible. The lithium can be evaporated, for example, by thermal evaporation techniques or by electron beam evaporation techniques.

In some implementations, any of the processing chambers 310-340 of the flexible substrate coating apparatus 300 may be configured for performing deposition by sputtering, such as magnetron sputtering. As used herein, “magnetron sputtering” refers to sputtering performed using a magnet assembly, that is, a unit capable of a generating a magnetic field. Typically, such a magnet assembly includes a permanent magnet. This permanent magnet is typically arranged within a rotatable target or coupled to a planar target in a manner such that the free electrons are trapped within the generated magnetic field generated below the rotatable target surface. Such a magnet assembly may also be arranged coupled to a planar cathode.

In some implementations, one or some of the processing chambers 310-340 may be configured for performing sputtering without a magnetron assembly. In some implementations, one or some of the chambers 310-340 may be configured for performing deposition by other methods, such as, but not limited to, chemical vapor deposition, atomic laser deposition or pulsed laser deposition. In some implementations, one or some of the chambers 310-340 may be configured for performing a plasma treatment process, such as a plasma oxidation or plasma nitridation process.

In certain implementations, the processing chambers 310-340 are configured to process both sides of the continuous sheet of material 350. The processing chambers 310-340 may be configured to process both sides of the continuous sheet of material 350 simultaneously. Although the flexible substrate coating apparatus 300 is configured to process the continuous sheet of material 350, which is horizontally oriented, the flexible substrate coating apparatus 300 may be configured to process substrates positioned in different orientations, for example, the continuous sheet of material 350 may be vertically oriented. In certain implementations, the continuous sheet of material 350 is a flexible conductive substrate. In certain implementations, the continuous sheet of material 350 includes a conductive substrate with one or more layers formed thereon. In certain implementations, the conductive substrate is a copper substrate.

In certain implementations, the flexible substrate coating apparatus 300 comprises a transfer mechanism 352. The transfer mechanism 352 may comprise any transfer mechanism capable of moving the continuous sheet of material 350 through the processing region of the processing chambers 310-340. The transfer mechanism 352 may comprise a common transport architecture. The common transport architecture may comprise a reel-to-reel system with a common take-up-reel 354 positioned in the winding module 306, the coating drum 355 positioned in the processing module 304, and a feed reel 356 positioned in the unwinding module 302. The take-up reel 354, the coating drum 355, and the feed reel 356 may be individually heated. The take-up reel 354, the coating drum 355 and the feed reel 356 may be individually heated using an internal heat source positioned within each reel or an external heat source. The common transport architecture may further comprise one or more auxiliary transfer reels 353a, 353b positioned between the take-up reel 354, the coating drum 355, and the feed reel 356. Although the flexible substrate coating apparatus 300 is depicted as having a single processing region, in certain implementations, it may be advantageous to have separated or discrete processing regions for each individual processing chamber 310-340. For implementations having discrete processing regions, modules, or chambers, the common transport architecture may be a reel-to-reel system where each chamber or processing region has an individual take-up-reel and feed reel and one or more optional intermediate transfer reels positioned between the take-up reel and the feed reel.

The flexible substrate coating apparatus 300 may comprise the feed reel 356 and the take-up reel 354 for moving the continuous sheet of material 350 through the different processing chambers 310-340. In one implementation, the first processing chamber 310, the second processing chamber 320, and the third processing chamber 330 are each configured to deposit a portion of a lithium layer or lithium metal film. The fourth processing chamber 340 is configured to deposit a surface protection layer over the lithium layer, such as a lithium oxide or lithium fluoride film. In one embodiment, the fourth processing chamber 340 is configured to deposit a surface protection layer comprises a plasma source for depositing the surface protection layer. In some implementations, the finished negative electrode will not be collected on the take-up reel 354 as shown in the figure, but may go directly for integration with the separator and positive electrodes, etc., to form capacitors.

In another implementation, the first processing chamber 310 is configured to deposit a graphite coating on the continuous sheet of material 350. The second processing chamber 320 and the third processing chamber 330 are each configured to deposit a portion of a lithium layer or lithium metal film. The fourth processing chamber 340 is configured to deposit a surface protection layer over the lithium layer, such as a lithium oxide or lithium fluoride film. In one embodiment, the fourth processing chamber 340 is configured to deposit a surface protection layer comprises a plasma source for depositing the surface protection layer. The plasma source may be a carbon dioxide plasma source used to treat the lithium layer.

In yet another implementation, each processing chamber 310-340 is configured for depositing a thin film or layer of lithium metal on the continuous sheet of material 350. Any suitable lithium deposition process for depositing thin films of lithium metal may be used to deposit the thin film of lithium metal. Deposition of the thin film of lithium metal may be by PVD processes, such as evaporation, a slot-die process, a transfer process, a lamination process or a three-dimensional lithium printing process. The chambers for depositing the thin film of lithium metal may include a PVD system, such as an electron-beam evaporator, a thin film transfer system (including large area pattern printing systems such as gravure printing systems), a lamination system, or a slot-die deposition system. In one implementation, deposition of the thin film of lithium metal is by an evaporation chamber. In such an implementation, the evaporation chamber may have a processing region that comprises an evaporation source that may be placed in a crucible, which may be a thermal evaporator or an electron beam evaporator (cold) in a vacuum environment, for example.

In operation, the continuous sheet of material 350 is unwound from the feed reel 356 as indicated by the substrate movement direction shown by arrow 308. The continuous sheet of material 350 may be guided via one or more auxiliary transfer reels 353a, 353b. It is also possible that the continuous sheet of material 350 is guided by one or more substrate guide control units (not shown) that shall control the proper run of the flexible substrate, for instance, by fine adjusting the orientation of the flexible substrate.

After uncoiling from the feed reel 356 and running over the auxiliary transfer reel 353a, the continuous sheet of material 350 is then moved through the deposition areas provided at the coating drum 355 and corresponding to positions of the deposition units 312, 322, 332, and 342. During operation, the coating drum 355 rotates around axis 351 such that the flexible substrate moves in the direction of arrow 308.

Using the flexible substrate coating apparatus for pre-lithiation allows for direct, precise dosing of lithium on an anode of a lithium ion capacitor. Dosing the lithium directly on the anode enables the lithium to be uniformly deposited on the anode in a quicker and more efficient manufacturing process. As such, in some embodiments, utilizing the flexible substrate coating apparatus is an effective method the for pre-lithiation of lithium ion capacitor anodes, enabling a higher, more efficient production of LICs having one or more of the following: (i) a high voltage (˜4 V) without excess charging, (ii) the suppression of the irreversible capacity of the negative electrode (i.e., the anode), (iii) reduced electrode resistance, (iv) reduced lithium consumption from the electrolyte, (v) an extended cycle life, and (vi) a high energy density through the extended potential swing of the positive electrode (i.e., the cathode).

While the foregoing is directed to embodiments of the present disclosure, other and further embodiments of the disclosure may be devised without departing from the basic scope thereof, and the scope thereof is determined by the claims that follow.

What is claimed is:

1. A method for pre-lithiating one or more lithium ion capacitor anodes, comprising:
providing a substrate to a flexible substrate coating apparatus as a continuous sheet of anode material, wherein the substrate comprises one or more anodes; and
depositing a lithium layer onto one or more sides of the substrate using the flexible substrate coating apparatus.

2. The method of claim 1, wherein the flexible substrate coating apparatus comprises one or more processing units, each processing unit comprising a deposition unit.

3. The method of claim 2, wherein at least one deposition unit comprises an evaporation source, the evaporation source being a lithium source.

4. The method of claim 3, wherein depositing the lithium layer onto the substrate comprises evaporating the lithium by thermal evaporation techniques using the lithium source.

5. The method of claim 1, wherein the lithium layer has a thickness of about 0.01 μm to 5 μm.

6. The method of claim 5, wherein the lithium layer has a thickness of about 1 μm to 3 μm.

7. The method of claim 1, wherein depositing the lithium layer onto the one or more sides of the substrate comprises depositing lithium layers onto both sides of the substrate simultaneously.

8. A method for pre-lithiating one or more lithium ion capacitor anodes, comprising:
providing a substrate to a flexible substrate coating apparatus as a continuous sheet of anode material, wherein the substrate comprises one or more anodes;
depositing a lithium layer onto one or more sides of the substrate using the flexible substrate coating apparatus; and
depositing a surface protection layer on the lithium layer using the flexible substrate coating apparatus.

9. The method of claim 8, wherein the flexible substrate coating apparatus comprises one or more processing units, each processing unit comprising a deposition unit, and wherein at least one deposition unit comprises an evaporation source, the evaporation source being a lithium source.

10. The method of claim 9, wherein depositing the lithium layer onto the substrate comprises evaporating the lithium by thermal evaporation techniques using the lithium source.

11. The method of claim 8, wherein the surface protection layer is deposited using a plasma source of the flexible substrate coating apparatus.

12. The method of claim 8, wherein the surface protection layer comprises lithium oxide, lithium carbonate, or lithium fluoride.

13. The method of claim 8, wherein the lithium layer has a thickness of about 1 μm to 3 μm.

14. A method for pre-lithiating one or more lithium ion capacitor anodes, comprising:
doping lithium ions onto a substrate comprising one or more anodes using thermal evaporation; and
depositing a surface protection layer on the lithium ion doped substrate.

15. The method of claim 14, wherein the surface protection layer comprises lithium oxide, lithium carbonate, or lithium fluoride.

16. The method of claim 14, wherein the surface protection layer is deposited using a plasma source of a flexible substrate coating apparatus.

17. The method of claim 14, wherein depositing the surface protection layer comprises treating the substrate with carbon dioxide.

18. The method of claim 14, wherein the one or more anodes of the substrate comprise a non-porous material coated in graphite or carbon, and wherein the one or more anodes of the substrate each comprise an electrode and a current collector.

19. The method of claim 18, further comprising:
depositing a hardmask on the current collector of each of the one or more anodes of the substrate prior to doping the lithium ions, wherein the lithium ions are doped onto the electrode of each of the one or more anodes of the substrate; and
removing the hardmask prior to depositing the surface protection layer.

20. The method of claim 14, wherein doping lithium ions onto the substrate and depositing the surface protection layer are performed without breaking vacuum.
